(19) United States
(12) Patent Application Publication
(10) Pub. No.: US 2011/0191758 A1
(43) Pub. Date: Aug. 4, 2011

(54) Optimized Memory Allocator By Analyzing Runtime Statistics

(76) Inventor: Michael SCHARF, Heidelberg (DE)

(21) Appl. No.: 12/696,284

(22) Filed: Jan. 29, 2010

(51) Int. Cl. G06F 9/45; G06F 12/00; G06F 12/02

(52) U.S. Cl. 717/151; 711/170; 711/E12.001; 711/E12.002

(57) ABSTRACT

A computer readable storage medium including a set of instructions executable by a processor. The set of instructions operable to determine memory allocation parameters for a program executing using a standard memory allocation routine, create an optimized memory allocation routine based on the memory allocation parameters and execute the program using the optimized memory allocation routine.

### BACKGROUND

A computer system is comprised of numerous different components, each of which has a particular function in the operation of the computer system. For example, FIG. 1 depicts an exemplary embodiment of a typical personal computer (“PC”) 100 which may be a computing device or other microprocessor-based device including processor 110, system memory 115, hard drive 120, disk drive 125, I/O devices 130, a display device 135, keyboard 140, mouse 145 and a connection to communication network 150 (e.g., the Internet). Each of these devices in the PC has one or more functions, which allow the PC to operate in the manner intended by the user. For example, the hard drive 120 stores data and files that the user may wish to access while operating the PC, the disk drive 125 may allow the user to load additional data into the PC, the I/O devices 130 may include a video card which allows output from the PC to be displayed on CRT display device 135.

The system memory 115 may be, for example, Random Access Memory (“RAM”), which is a type of memory for storage of data on a temporary basis. In contrast to the memory in the hard drive 120, the system memory 115 is short-term memory, which is essentially erased each time the PC 100 is powered off. The system memory 115 holds temporary instructions and data needed to complete certain tasks. This temporary holding of data allows the processor 110 to access instructions and data stored in the system memory 115 very quickly. If the processor 110 were required to access the hard drive 120 or the disk drive 125 each time it needed an instruction or data, it would significantly slow down the operation of the PC. All the software currently running on the PC requires some portion of the system memory 115 for proper operation. For example, the operating system, currently running application programs and networking software may all require some portion of the memory space in the system memory 115. Using the example of an application program, when the user of the PC enters a command in the keyboard 140 or the mouse 145 to open a word processing program, this command is carried out by the processor 110. Part of executing this command is for data and instructions stored in the hard drive 120 for the word processing program to be loaded into the system memory 115 which can provide data and instructions to the processor 110 more quickly than the hard drive 120 as the user continues to enter commands for the word processing program to execute.

When a computer program needs to use system memory, it makes a call to the processor 110 for some available memory from the system memory 115. The program may make a static memory call where the program is given the requested amount of memory from the stack, if available, for the entire duration that the program is run. However, two problems arise. First, if the program requests more memory than it actually needs, the rest of the memory is wasted. By allocating the entire memory up front, the program denies access to the unused portion of the memory, which could be used by another program. Second, if the program requests too little memory then the program may crash once it has used up all if its requested memory. The program could also use an automatic memory allocation routine. In an automatic memory allocation routine, memory from the stack is called, when needed, and then returned when no longer required. The problem with memory allocated from the stack is it cannot persist among multiple function calls. So greater flexibility is required when allocating memory.

Dynamic memory allocation has been used to solve the problems above. A malloc call requests memory from the heap. If the memory is available a pointer is returned to the program. The program uses the requested memory and then calls a free command once the memory is no longer required. The advantages of a malloc call are first, the memory is provided from the heap and not the stack. Second, the program makes calls for memory as needed so it does not reserve memory that it will not use. The problems with a standard malloc call are that each malloc call requires a certain amount of administrative overhead, so there can be a lot of wasted space from many malloc calls. Second, fragmentation occurs when there are many small malloc calls culling from memory in different locations on the heap. Finally, more processing power is required since each malloc calls requires its own processing time.

### SUMMARY OF THE INVENTION

A method for determining memory allocation parameters for a program executing using a standard memory allocation routine, creating an optimized memory allocation routine based on the memory allocation parameters and executing the program using the optimized memory allocation routine.

A computer readable storage medium including a set of instructions executable by a processor. The set of instructions operable to determine memory allocation parameters for a program executing using a standard memory allocation routine, create an optimized memory allocation routine based on the memory allocation parameters and execute the program using the optimized memory allocation routine.

A system having a memory and a processor for determining memory allocation parameters, of the memory, for a program executed using a standard memory allocation routine, creating an optimized memory allocation routine based on the memory allocation parameters, and executing the program using the optimized memory allocation.

### BRIEF DESCRIPTION OF DRAWINGS

FIG. 1 depicts an exemplary computing device.

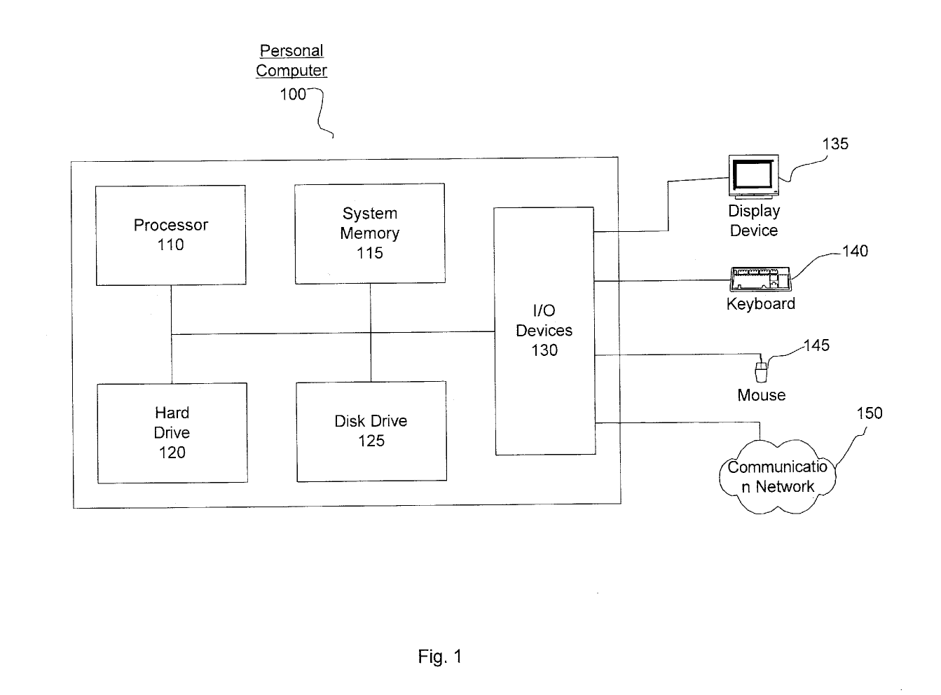

FIG. 2 depicts an exemplary method for determining an optimized memory routine.

FIG. 3 depicts am exemplary method for memory allocation using the exemplary optimized allocation routine.

FIG. 4 depicts an exemplary self-adapting memory optimization.

### DETAILED DESCRIPTION

The exemplary embodiments of the present invention may be further understood with reference to the following description and the appended drawings, wherein like elements are provided with the same reference numerals. The exemplary embodiments generally relate to a system and method for optimizing memory allocation using an optimization routine. Specifically, the exemplary method allows the programmer of an application to determine the optimized memory allocation and compile the optimized memory allocation into the program. Throughout this specification the term memory will be used, and it should be understood that this term may refer to any type of RAM, for example, Static RAM (“SRAM”), Dynamic RAM (“DRAM”), Synchronous DRAM (“SDRAM”), Enhanced DRAM (“EDRAM”), etc., but also to any type of volatile memory device that stores data and/or instructions for use by a computing device. Additionally, throughout this specification, the memory will be discussed as being accessed and allocated by a processor or microprocessor and it should be understood that the present invention may be implemented in any computing and/or electronic device where processors and/or microprocessors perform such functions, for example, PCs, servers, internet devices, embedded devices, or any computing device.

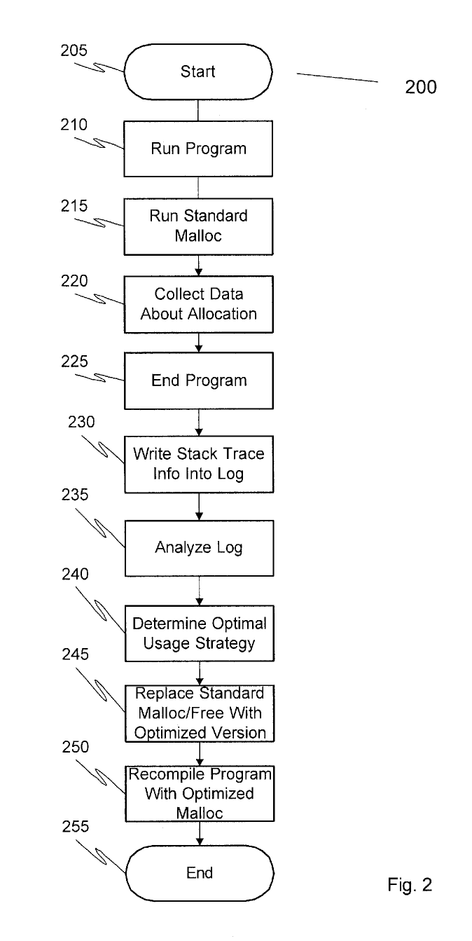

FIG. 2 shows an exemplary method 200 for determining the optimized memory allocation routine. In step 205 the method begins. In step 210 a programmer runs the optimization routine. The optimization routine is designed to gather information about the memory usage of any program that is run. The optimization routine could be designed to look at the memory requirements of a specific program, or just look at all memory requirements during the running of the program. While it is preferable to get only the memory requirements of the specific program, it may be easier to compute the entirety of the memory requirements during a given period than it is to determine the memory requirements of a specific program. This optimization routine is preferably done after a program has been completed, and has been fully tested. It should be noted, however, that the optimization routine could be done at any time during the development/testing of the program, and can be rerun as the program changes.

In step 205 the programmer starts the memory optimization routine. The optimization routine will gather information about the memory usage requirements of a program. The optimization routine will constantly monitor all memory calls by the program. The optimization can be run in the background, which normally means the programmer does not see the progress of the optimization routine until the optimization routine has ended. The optimization routine may also be run in the foreground, allowing the programmer to monitor the memory usage of the running program. It should be noted that the optimization routine may be run in both the background or the foreground, allowing the programmer to monitor or not monitor the memory usage at any point in time.

In step 210 the programmer runs the program whose memory requirements are to be analyzed. The program can be run by the user in a full, normal usage mode, or the programmer can run the programmer in a simulator. In a full, normal usage mode, the programmer runs the program as if he were the end user. The programmer goes through the steps of activating the program and using its standard features. Using more features and functions, and spending more time on the program will allow the optimization routine to gather the most information on the memory requirements. The greater the amount of information the better the optimization routine will be. It should be noted, again, that the programmer may design a simulation program to run through all of the features and functions without the need for the programmer to activate all of them. This is advantageous as the programmer can perform other duties while the simulation is running.

The programmer, however, may not choose to run through all the features and functions. Many programs have many functions that may be run infrequently, or not at all, by the user. The programmer may only run through the features and functions that will get used the most by the end user. This is advantageous in that less time is required by the optimization routine to determine the optimized memory allocation. This is also advantageous as the programmer may receive diminished returns by continuing to run the memory optimization routine on those functions that an end user may use infrequently. It should be noted, however, that the programmer can determine how many functions they wish to activate and can rerun the optimization routine until they believe the best outcome has been achieved. It should be further noted that multiple simulations can be performed on the program and the multiple outcomes can be exported to a file for the programmer to analyze and determine which optimization routine to use.

In step 215 a standard malloc is run. As noted above, a malloc is a standard dynamic memory allocation routine. A malloc comes in many forms and the programmer can choose which standard malloc function to run. It should be noted that the programmer may run the memory optimization using the same malloc, or the programmer may use different malloc functions loaded into the running program. Running the program using different mallocs may give the optimization routine more information to determine the optimized memory allocation for that program. The malloc is called every time the program requires some memory. Over the course of running the program, a malloc may be called many times.

In step 220 data is collected about the memory usage. The optimization routine collects data about the memory usage of the program. After each malloc call the optimization routine records the memory requirements of that specific malloc call. The optimization routine may record data about the thread that does the allocation and deallocation of the memory, the size of the allocated junks, access of the allocation, and the duration of the allocated memory. The optimization routine may further record data about the overhead cost of each malloc all, the processor requirements of each malloc call, and the memory fragmentation effect of each malloc call. The above examples are used for exemplary purposes only, as one skilled in the art understands there can be more data, concerning different parts of the memory allocation, recorded by the optimization program. It should be noted that the programmer may use any combination of the above examples in collecting data, or the programmer may add more data collection points into the routine. The more data points added to the optimization routine, the more information gathered, and the better the optimization routine will be. However, it may be more difficult to gather some of the data points depending on the program run, and the programmer may choose to allow or not allow specific data points when running the optimization routine.

In step 225 the program is closed. Once the programmer runs through all the features and function they wish to access in the program, or once the simulation ends, the program is shut down. This can happen after a predetermined time period, after a predetermined number of functions have been run, or at any time as determined by the programmer. It should be noted that the program can be terminated for any reason as determined by the programmer, and may further be any combination of the above reasons or any other reasons.

In step 230 all of the data collected is recorded in a stack trace log. The log contains all the data points the programmer wants to analyze. The log can be a single file containing all the data points, or the log can be multiple files, each file containing a single data point. It should be noted that there could be any combination of single or multiple files, and any number of data points on each file. The programmer determines the number of files, and number of data points in each file. The log can be stored in a specific file structure on the computer system with a generic name (e.g., stack-trace log). This log may be overwritten each time the programmer runs the optimization routine. The log may also be named for the program run, and the date and time of the optimization routine. This would not overwrite the previous log and would allow the programmer to keep back logs of all the optimizations run. It should be noted that the programmer could set up the log to be stored in any format, and or file extension, as the programmer sees fit. It should be further noted that the log can be stored locally on the optimization computer, can be printed out, or can be transferred to any location the programmer chooses.

In step 235 the optimization program analyzes the stack trace info log; this can be done automatically by the optimization routine once the program has been terminated and the log written. The optimization routine looks at the total number of malloc calls, and the memory requirements of each malloc call. The optimization routine can determine, for example, that it would be more advantageous to make one larger memory call in certain instances than many smaller memory calls. This could decrease the administrative overhead and prevent fragmentation. This can also be done at a later date as determined by the programmer. It should be noted that the programmer may also have access to the log and may adjust the log as they see fit.

In step 240 the optimization routine determines the optimal memory usage strategy. The optimization routine analyzes all the information in the log and determines how the program, or system the program is run on, may benefit from different memory call optimization strategies. The optimal strategy is a function of the data collected, but is also a function of what the programmer wishes to optimize. As noted above, memory calls can waste memory by reserving it, but not using it. Memory calls can fragment the available memory. And memory calls can affect the processing time required by the program. The optimization routine can be run to reduce one of the above problems. For example, the programmer can set the optimization to limit all or a selected amount of memory wasted. The programmer could also set the optimization routine to reduce all of the above problems. The optimization can be run to reduce the above problems, and any other problems associated with memory calls not listed above, in any combination. The programmer can further create multiple optimizations and determine, at a later time, which memory optimization routine to use.

In step 245 the standard malloc, from the previously run program, is replaced by the optimized memory allocation routine as determined by the optimization program. The new memory allocation routine is inserted directly into the source code of the program. The original malloc, from the original source code, is completely erased, and any new memory call will use the new optimized memory allocation routine placed in the source code.

In step 250 the program is recompiled. After the standard malloc has been replaced by the new optimized memory allocation routine in the source code, the program must be recompiled. The new, recompiled, program now includes the new memory allocation routine based on the optimization scheme chosen by the programmer. Once the program has been recompiled, in step 255 the optimization process ends. It should be noted, however, that the recompilation of the program may take place at any time after the optimization routine has been done. So the optimization routine may end without recompiling the program with the new memory allocation routine. It should be further noted that the optimization routine could be stopped and resumed at any time. For example the programmer may run the data collection portion of the routine, but save the analyzing portion for another time. Or, the programmer may stop the optimization after optimal strategies have been determined but before a new memory allocation routine is chosen by the programmer and inserted into the source code.

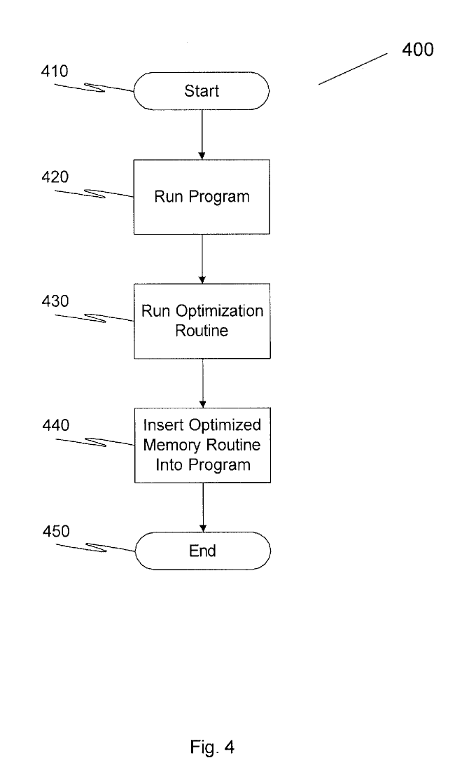

In exemplary method 200 the optimized memory allocation routine was inserted directly into the source code and recompiled. It should be noted, however, that the new memory allocation does not need to be inserted into the source code, and the program does not have to be recompiled for the new memory allocation routine to be used. The originally compiled program may include a table that points to the memory allocation routine to be used. During the optimization routine, the table would point to the standard malloc function. Once the optimization routine has been run, the standard malloc that the program originally pointed to would be replaced by the new memory allocation routine. This is advantageous in that the program does not need to be recompiled. This has further advantages that will be described below in reference to FIG. 4.

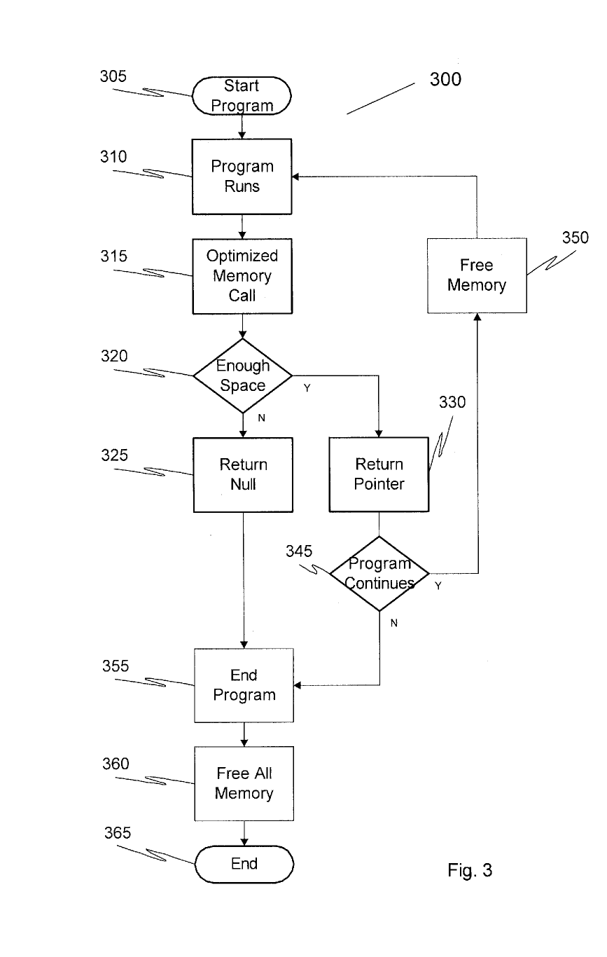

FIG. 3 shows an exemplary method 300 for running the optimized memory allocation routine in a program. In step 305 the end user starts the program. The program can be stored on the hard drive 120 or the disk drive 125. It should be noted, however, that program can be stored on any storage medium that can be read by the PC. The user can initiate the program at anytime. It should be noted, however, that the program can be a program called by the operating system and does not need to be run by the end user. Furthermore, the program does not need to be a program that can be run by and end user and can be any program capable of being run on the PC (e.g., a system program). In step 310 the program is run and functions and features of the program are activated by the end user. In step 315 the optimized memory routine is called. The optimized memory routine can be directly in the program, or can be pointed to externally, as described above. The optimized memory call, in step 315, makes a request to the processor 110 for memory from the system memory 115 in accordance with optimization routine previously run.

In step 320 the processor 110 determines if there is enough memory available in the system memory 115 to meet the requirements of the program. If there is insufficient memory available in the system memory 115 then a null is returned to the program in step 325. When a null is returned to, the program run in step 335, the program then ends in step 355 due to insufficient amount of memory. In step 360 all memory previously allocated to the program run in step 310 is freed. This gives other programs access to the memory previously used by the program run in step 310. In step 365 the method ends and the user is free to rerun the program, or run additional programs.

Referring back to step 320, if there is enough memory available in the system memory 115 then the processor 110 allocates the memory and returns a pointer to the program in step 330. The pointer points to the location within the system memory 115 where the allocated memory in step 330 is located. In step 345 the end user may choose to continue to run the program or to stop using the program. If the end user decides to stop using the program then the program is ended in step 355. The program then frees all of the previously used memory in step 360 and then ends in step 365. In step 350, if the user chooses to continue to use the program, any previously required memory, that is not longer required, is freed. This makes room for more memory calls from the current program, or from any other program. After unused memory is free, the method proceeds to step 310 where the program continues to run. In step 310 the user uses the features and functions of the program and any memory required is called using the optimized memory call in step 315.

FIG. 4 shows an exemplary method 400 for running the optimization routine on an end user's computer. The optimization routine can be the first time that the optimization routine has been run for this program. Which means the programmer has not run any optimization routine prior to the file compilation of the program. It further means that the initial memory call run for the first time is a standard malloc call. The optimization routine could further be a re-optimization routine. The programmer may have run an optimization routine prior to compiling the program and inserted a table into the program point to an optimized memory call. It can also correspond to a further optimization routine which has been done after a previous optimization routine has been performed on the end user's computer.

In step 410 the program initiates the optimization routine method, this can be done by the user, or it can be done automatically by the program. It can be done every time the program is run or after a certain number of instances the program has been run. It can further be done after a certain period of time has elapsed since the last optimization. It should be noted that the optimization can be set up to run at any time by the user or the program, not limited to the examples above. In step 420 the user runs the program they want to optimize. The program is used as the end user would normally use it. The end user will go through his normal features and functions. While the program is run a memory call is used, either an optimized memory call from a previous optimization or a standard malloc call if this is the first time the program is being optimized.

In step 430 the optimization program gathers data on the memory usage of the program while the end user runs the program. Similar to method 200, step 430 may record data about the thread that does the allocation and deallocation of the memory, the size of the allocated junks, access of the allocation, and the duration of the allocated memory. It should be noted, however, that the optimization program may use any combination of the above examples in collecting data, or the optimization program may add more data collection points into the routine. Further in step 430 the stack trace log is created and the data is analyzed to determine the optimized memory allocation routine. The program may determine which characteristics of a memory call it wishes to optimize (e.g., limiting processing power) or it may use a combination of all possible optimizations. The program may also give the user a choice as to what they want to optimize.

In step 440 the new optimized memory call is placed in the table, in place of the old memory call. Since the memory call routine is not compiled into the program, no recompilation of the program is necessary. In step 450 the optimization routine ends and any further running of the program will include the new optimized memory call, until a new instance of the optimization program is run. This method is advantageous since it allows the program to customize the memory optimization to the particular user of the program. It is also advantageous since the program can constantly update its memory allocation to fit the changing needs of an end user.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A method comprising:
determining memory allocation parameters for a program executing using a standard memory allocation routine;
creating an optimized memory allocation routine based on the memory allocation parameters; and
executing the program using the optimized memory allocation routine.

2. The method according to claim 1 wherein the memory allocation parameters includes data about at least one of the thread that does the allocation and deallocation, the size of the allocated junk, the access of allocation, and the duration of the allocated memory.

3. The method according to claim 1 wherein the optimized memory allocation routine is based on minimizing one of at least memory waste, memory fragmentation, and processing time.

4. The method according to claim 1 wherein in the optimized memory allocation routine is run on the program and then recompiled into the source code.

5. The method according to claim 1 wherein the optimized memory allocation routine is run on the end user's computer.

6. The method according to claim 1 wherein the optimized memory allocation routine is run at various intervals to update the optimized memory allocation routine.

7. The method according to claim 1 wherein the optimized memory allocation routine is stored in a separate database.

8. The method according to claim 1 wherein the memory allocation parameters are stored in a log.

9. The method according to claim 1 wherein the memory allocation parameters are output to a user.

10. A computer readable storage medium including a set of instructions executable by a processor,
the set of instructions operable to:
determine memory allocation parameters for a program executing using a standard memory allocation routine;
create an optimized memory allocation routine based on the memory allocation parameters; and
execute the program using the optimized memory allocation routine.

11. The method according to claim 10 wherein the memory allocation parameters include data about at least one of the thread that does the allocation and deallocation, the size of the allocated junk, the access of allocation, and the duration of the allocated memory.

12. The method according to claim 10 wherein the optimized memory allocation routine is based on minimizing one of at least memory waste, memory fragmentation, and processing time.

13. The method according to claim 10 wherein in the optimized memory allocation routine is run on the program and then recompiled in the source code.

14. The method according to claim 10 wherein the optimized memory allocation routine is run on the end user's computer.

15. The method according to claim 10 wherein the optimized memory allocation routine is run at various intervals to update the optimized memory allocation routine.

16. The method according to claim 10 wherein the optimized memory allocation routine is stored in a separate database.

17. The method according to claim 10 wherein the memory allocation parameters are stored in a log.

18. The method according to claim 10 wherein the memory allocation parameters are output to a user.

19. A system comprising:
a memory; and
a processor for determining memory allocation parameters, of the memory, for a program executed using a standard memory allocation routine,
creating an optimized memory allocation routine based on the memory allocation parameters, and
executing the program using the optimized memory allocation.

20. The system according to claim 20 wherein the memory is one of RAM, SRAM, DRAM, SDRAM, and EDRAM.
